(19) United States
(12) Patent Application Publication
(10) Pub. No.: US 2005/0103957 A1
(43) Pub. Date: May 19, 2005

(54) Support stand assembly for a computer desk

(76) Inventor: Mei-Li Chang, Fongshan City (TW)

Correspondence Address: DELLETT AND WALTERS, P. O. BOX 2786, PORTLAND, OR, 97208-2786, US

(21) Appl. No.: 10/717,013

(22) Filed: Nov. 19, 2003

(51) Int. Cl. F16M 11/00

(52) U.S. Cl. 248/127; 248/311.2; 248/918

(57) ABSTRACT

A support stand assembly for a computer desk has a base (12), a column (11) detachably mounted on the base (12), and a headphone mount (10) attached to the column (11). The base (12) has a top face and multiple margin flanges (125) formed on the top face to define an enclosure (122) for placing a computer mouse, and multiple threaded holes defined in the top face to selectively engage with pillars to attach multiple fittings to the base (12). Thereby, the support stand assembly enables the arrangement of the headphone, the mouse device and other accessories on the support stand assembly in order to keep the computer desk neat.

### BACKGROUND OF THE INVENTION

1. Field of the Invention

The invention relates to a support stand assembly, and particularly to a support stand assembly that is adapted to place on a multimedia desk to arrange a headphone and a mouse on the support stand assembly.

2. Description of Related Art

Computers have become common multimedia devices in daily life as they have multiple functions such as playing games or playing music and movies to provide more entertainment to a user. In order to enjoy the multiple functions, accessories such as headphones and mouse devices are attached to the computer and placed on a computer desk. However, the headphones and the mouse devices do not have specific accommodating places to be arranged in order and so make the computer desk look a mess. Sometimes the accessories may be damaged when the user throws the accessories on the computer desk or may not be found when the computer desk is in a mess.

For a cybercafe manager, keeping the computer desk neat is an important factor to attract consumers to enter the cybercafe. Therefore, the accessories on the computer desk for each computer become appearance problems of cybercafes and other related establishments.

The present invention has arisen to provide a support stand assembly for a computer desk to keep the computer desk neat.

### SUMMARY OF THE INVENTION

A first objective of the present invention is to provide a support stand assembly that conveniently holds computer accessories to keep them in order.

A second objective of the present invention is to provide a support stand assembly that can be easily combined and has versatile modification.

Further benefits and advantages of the present invention will become apparent after a careful reading of the detailed description in accordance with the drawings.

### BRIEF DESCRIPTION OF THE DRAWINGS

FIG. 1 is a perspective view of a support stand assembly in accordance with the present invention;

FIG. 2 is an exploded perspective view of the support stand assembly in FIG. 1;

FIG. 3 is an operational perspective view of the support stand assembly as in FIG. 1, showing arrangement of a headphone and a mouse device;

FIG. 4 is a perspective view of another embodiment of the support stand assembly in accordance with the present invention, wherein a note paper box and a writing instrument container are added; and

FIG. 5 is a perspective view of still another embodiment of the support stand assembly in accordance with the present invention, wherein an extending rod is added.

### DETAILED DESCRIPTION OF THE PREFERRED EMBODIMENT

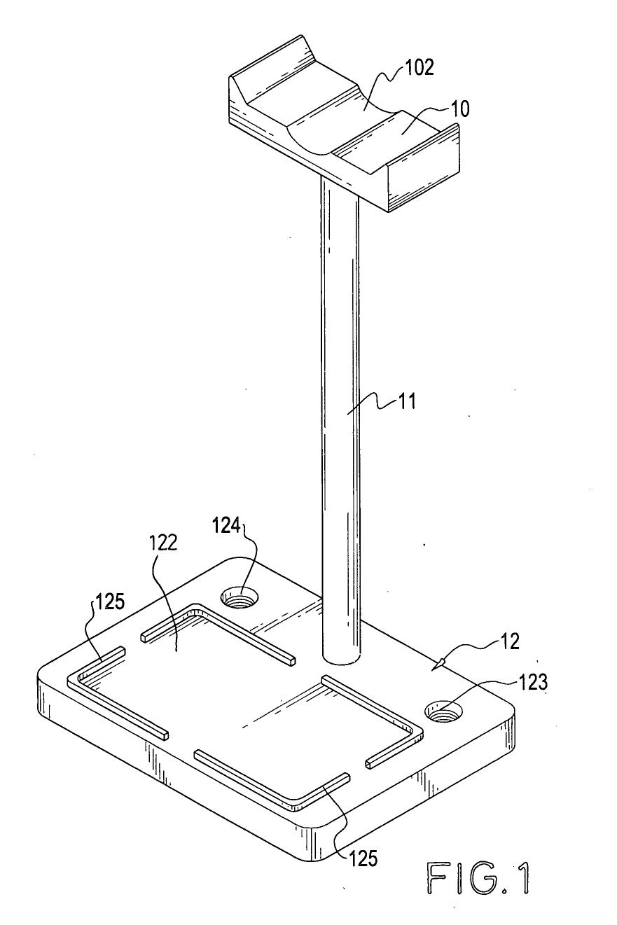

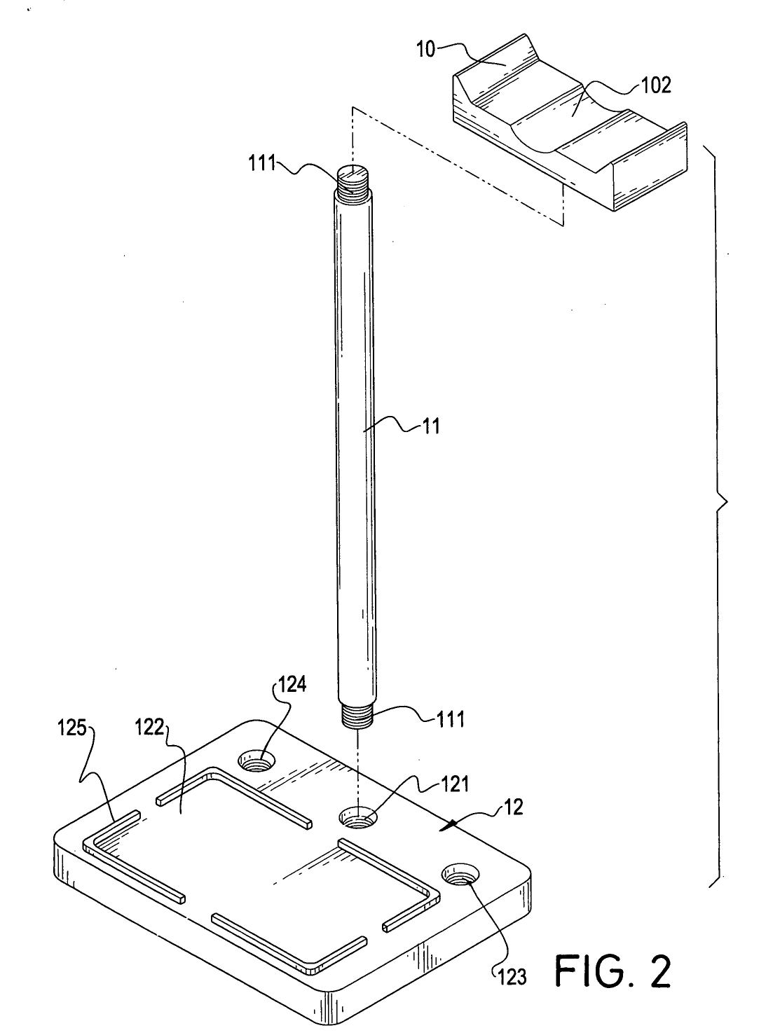

With reference to FIGS. 1 and 2, a support stand assembly in accordance with the present invention comprises a base (12), a column ( 11), and a headphone mount (10).

The base (12) is a rectangular plate with a top face, a front end, and a rear end. The base (12) has three threaded holes (121, 123, 124) defined in the top face at the rear end and multiple margin flanges (125) formed on the top face near the front end to define a rectangular enclosure (122) for a mouse device.

The column (11) is detachably mounted on the base (12) and has two threaded ends (111). One threaded end (111) of the column (11) screws into one of the threaded holes (121, 123, 124) in the base (12) to mount the column (11) on the base (12). The other threaded end (111) of the column (11) detachably engages the headphone mount (10).

The headphone mount (10) is detachably mounted on the column (11) and is a rectangular block with a top face, a bottom face and two ends. The headphone mount (10) has two protrusions respectively formed at the two ends of the headphone mount (10) and a transversal recess (102) defined at a middle portion on the top face. Additionally, a threaded hole (not shown) is defined in the bottom face of the headphone mount (10) to engage the threaded end (111) of the column (11).

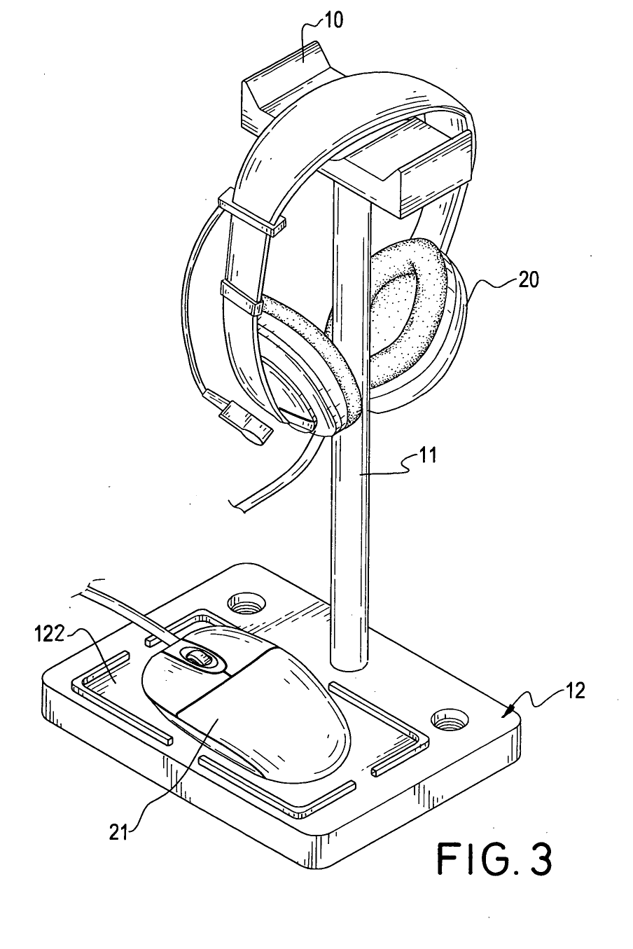

With further reference to FIG. 3, when the support stand assembly is used, a U-shaped headphone (20) with a bridge (not numbered) and two ear covers (not numbered) hangs on the headphone mount (10) by resting the bridge in the transversal recess (102) on the headphone mount (10). The mouse (21) is placed within the rectangular enclosure (122) defined by the margin flanges (125). Thereby, the headphone (20) and the mouse (21) both are collected together and arranged in order to keep the computer desk neat.

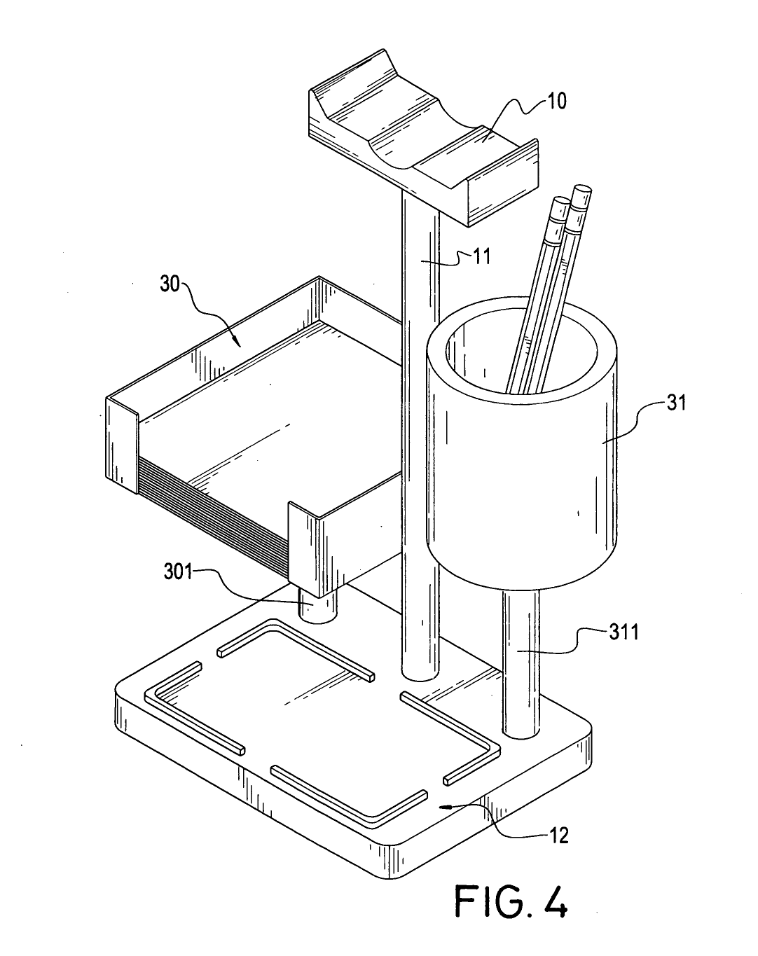

With reference to FIG. 4, the support stand assembly further selectively comprises other fittings such as a notepaper-box (30) and a writing instrument container (31) detachably mounted on the base (12) by means of a first pillar and a second pillar (301, 311) in the same way with the column (11) as described. Thereby, the support stand assembly can provide more accommodating functions to arrange more accessories such as notepaper and pens on the computer desk. Additionally, other fittings such as compact disk box (not shown) and a memo board (not shown) can substitute the notepaper box (30) and the instrument holder (31) to attach to the base (12) in the same manner by a third pillar and a fourth pillar (now shown).

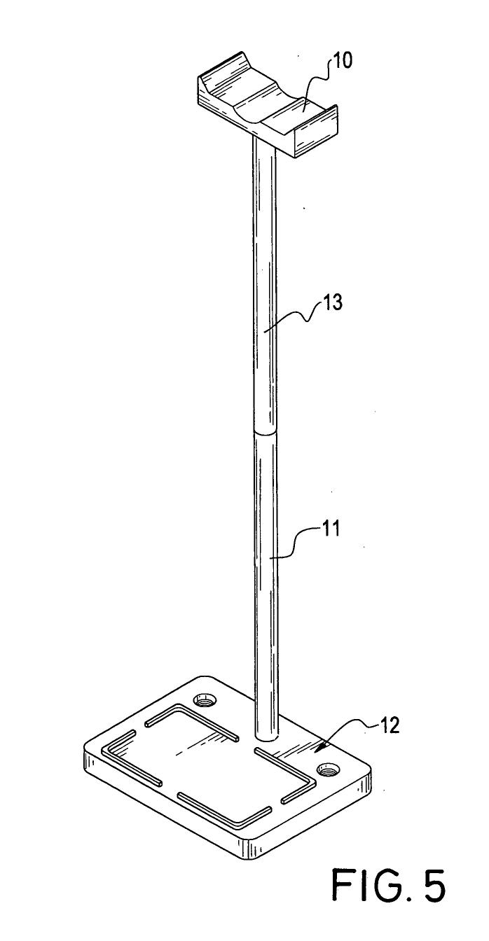

With reference to FIG. 5, the support stand assembly further comprises an extension rod (13) connected between the column (11) and the headphone mount (10) to increase the height of the headphone mount (10).

Based on the foregoing description, the support stand assembly holds the accessories of the computer at specific locations to keep the accessories in order and to keep the computer desk neat. Additionally, the support stand assembly has versatile modification to attach other fittings to arrange more accessories on the computer desk, or to detach the disused fittings from the support stand assembly to decrease the occupied space.

Although the invention has been explained in relation to its preferred embodiment, many other possible modifications and variations can be made without departing from the spirit and scope of the invention as hereinafter claimed.

1. A support stand assembly for a computer desk comprising:
a base (12) with a top face, a front end, and a rear end and having multiple margin flanges (125) formed on the top face near the front end;
a column (11) detachably mounted on the base (12); and
a headphone mount (10) detachably mounted on the column (11) and having a top face and a transversal recess (102) defined in the top face of the headphone mount;
wherein the margin flanges (125) define a flat area for surrounding a mouse on the top face of the base (12).

2. The support stand assembly as claimed in claim 1, wherein the base (12) has at least one threaded hole (121) defined in the top face near the rear end; and
the column (11) has two threaded ends (111), one of the threaded ends engages with one of the at least one threaded holes in the base (12).

3. The support stand assembly as claimed in claim 2, wherein the support stand assembly further has a notepaper box (30) with a first pillar (301) attached to the base (12) and a writing instrument container (31) with a second pillar (311) attached to the base (12);
the base (12) has three threaded holes, a first one of the three threaded holes engages with the column (11) with the headphone mount (10), a second one of the three threaded holes engages with the first pillar (301) of the notepaper box (30), and a third one of the three threaded holes engages with the second pillar (311) of the writing instrument container (31).

4. The support stand assembly as claimed in claim 2, wherein the headphone mount (10) further has a bottom face and a threaded hole defined in the bottom face to engage with the other one of the threaded ends (111) of the column (11).

5. The support stand assembly as claimed in claim 1, wherein the support stand assembly further has an extension rod (13) detachably connected between the column (11) and the headphone mount (10).
